(19) United States
(12) Patent Application Publication
(10) Pub. No.: US 2009/0292731 A1
(43) Pub. Date: Nov. 26, 2009

(54) Method And Apparatus For Generating A Composite Media File

(75) Inventor: Wannie Park, Arcadia, CA (US)

Correspondence Address: BRYAN CAVE LLP, TWO NORTH CENTRAL AVENUE, SUITE 2200, PHOENIX, AZ, 85004, US

(73) Assignee: Belkin International, Inc., Compton, CA (US)

(21) Appl. No.: 12/126,800

(22) Filed: May 23, 2008

(51) Int. Cl. G06F 17/00

(52) U.S. Cl. 707/104.1; 707/E17.009

(57) ABSTRACT

A number of embodiments concern a method of generating a composite media file. The method can include: (a) storing a first media file over an information sharing network from a first user to a database; (b) storing a first tag over the information sharing network for the first media file to provide first information regarding the first media file; (c) storing a second media file over the information sharing network from a second user to the database; (d) storing a second tag over the information sharing network for the second media file to provide second information regarding the second media file; (e) facilitating a search over the information sharing network for the first media file in the database based on the first information; and (f) storing the composite media file comprising a combination of at least the first media file and portions of the second media file. Other embodiments are disclosed in this application.

### FIELD OF THE INVENTION

This invention relates generally to apparatuses and methods for generating media files, and relates more particularly to apparatuses and method for allowing users to find media files and creating composite media files from these media files.

### DESCRIPTION OF THE BACKGROUND

Audio sequencers and mixers allow musicians to edit and process music. For example, a drummer can record herself playing the drums and use an audio sequencer to combine the audio of the drums with a recording of a guitar. However, if the drummer did not know a guitarist willing to provide her with a recording of his guitar playing, she could not create a composite audio file using the audio sequencer. Furthermore, non-musicians may want to create music by combining recording of others, but they might not have access to the desired audio files.

Accordingly, a need or potential for benefit exists for an apparatus or system that allows users to upload and share media files with others and create composite media files.

### BRIEF DESCRIPTION OF THE DRAWINGS

To facilitate further description of the embodiments, the following drawings are provided in which:

FIG. 1 is a diagram illustrating a system for generating a composite media file, according to a first embodiment;

FIG. 2 illustrates an example of main window of a graphical user interface of FIG. 1, according to the first embodiment;

FIG. 3 is a flow chart illustrating a method for generating a composite media file, according to the first embodiment;

FIG. 4 illustrates an example of an upload window of the graphical user interface of FIG. 1, according to the first embodiment;

FIG. 5 illustrates an example of an indication window of the graphical user interface of FIG. 1, according to the first embodiment;

FIG. 6 illustrates an example of a search window of the graphical user interface of FIG. 1, according to the first embodiment;

FIG. 7 illustrates an example of a sequencer window of the graphical user interface of FIG. 1, according to the first embodiment;

FIG. 8 illustrates an example of a media player window of the graphical user interface of FIG. 1, according to the first embodiment;

FIG. 9 illustrates a computer that is suitable for implementing an embodiment of the system of FIG. 1; and

FIG. 10 illustrates a representative block diagram of the elements included on circuit boards inside a chassis of the computer of FIG. 9.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments described herein are, for example, capable of operation in other orientations than those illustrated or otherwise described herein. The term “on,” as used herein, is defined as on, at, or otherwise adjacent to or next to or over.

The terms “couple,” “coupled,” “couples,” “coupling,” and the like should be broadly understood and refer to connecting two or more elements or signals, electrically and/or mechanically, either directly or indirectly through intervening circuitry and/or elements. Two or more electrical elements may be electrically coupled, either direct or indirectly, but not be mechanically coupled; two or more mechanical elements may be mechanically coupled, either direct or indirectly, but not be electrically coupled; two or more electrical elements may be mechanically coupled, directly or indirectly, but not be electrically coupled. Coupling (whether only mechanical, only electrical, or both) may be for any length of time, e.g., permanent or semi-permanent or only for an instant.

“Electrical coupling” and the like should be broadly understood and include coupling involving any electrical signal, whether a power signal, a data signal, and/or other types or combinations of electrical signals. “Mechanical coupling” and the like should be broadly understood and include mechanical coupling of all types.

### DETAILED DESCRIPTION OF EXAMPLES OF EMBODIMENTS

A number of embodiments concern a method of generating a composite media file. The method can include: (a) storing a first media file received over an information sharing network from a first user to a database; (b) storing a first tag received over the information sharing network for the first media file to provide first information regarding the first media file; (c) storing a second media file received over the information sharing network from a second user to the database; (d) storing a second tag received over the information sharing network for the second media file to provide second information regarding the second media file; (e) facilitating a search over the information sharing network for the first media file in the database based on the first information; and (f) storing the composite media file comprising a combination of at least portions of the first media file and the second media file.

In other embodiments, a method of combining a first audio file and a second audio file includes: (a) uploading the first audio file over an information sharing network to a database; (b) adding a first indication to the first audio file in the database over the information sharing network, the first indication having information about the first audio file; (c) searching the database for a second indication about the second audio file over the information sharing network; and (d) combining at least portions of the first audio file and the second audio file into a composite audio file.

In yet another embodiment, a media composition apparatus can include: (a) an upload module configured to upload at least three first media files over the information sharing network; (b) an indicator module configured to facilitate coupling one or more tags to the at least three first media files; (c) a query module configured to allow the user to search the at least three first media files by searching the indications of each of the at least three media files; and (d) a sequencer module configured to allow the user to create a second media file by combining at least portions of two or more media files of the at least three first media files.

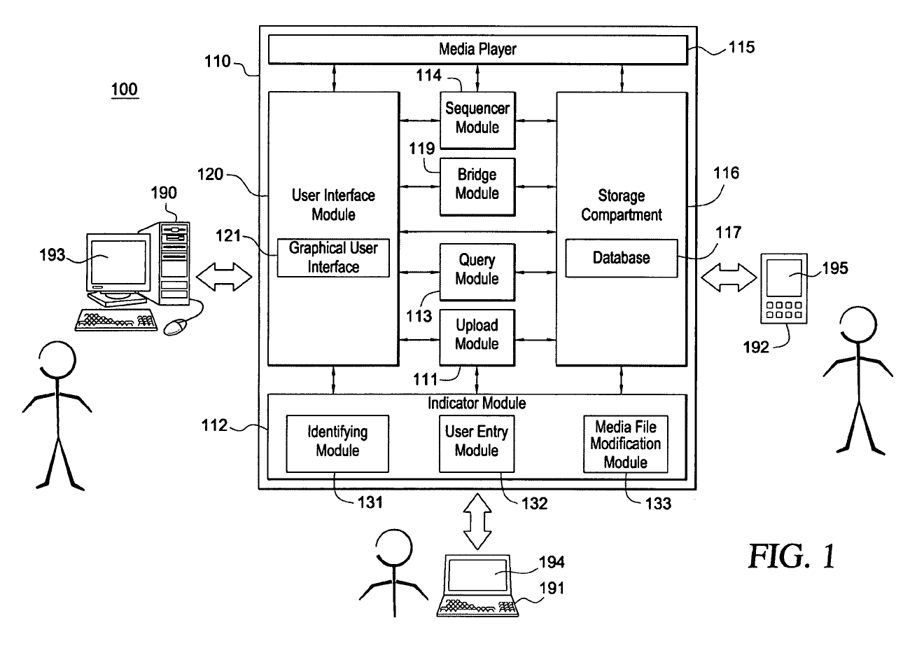

Turning to the drawings, FIG. 1 is a diagram illustrating a system 100 for generating a composite media file, according to a first embodiment. In some embodiments, system 100 can include: (a) a media composition apparatus 110; and (b) one or more interface devices 190, 191, and 192 with display units 193, 194, and 195, respectively. In some examples, interface devices 190, 191, and 192 can be computers, cellular telephones, personal digital assistants (PDAs), digital media players, or other types of devices having communication capabilities. In the same or different example, media composition apparatus 110 can be a general purpose computer or server.

Media composition apparatus 110 and interface devices 190, 191, and 192 can be coupled together by various information sharing networks including, without limitation, distributed information exchange networks, such as public and private computer networks (e.g., the Internet, intranets, WAN (wide area network), LAN (local area network), etc.), value-added networks, communications networks (e.g., wired or wireless networks), broadcast networks, and a homogeneous or heterogeneous combination of such networks. These information sharing networks include both hardware and software and can be viewed as either, or both, according to which description is most helpful for a particular purpose.

The Internet is an example of an information sharing network including a computer network in which the embodiments of system 100 can be implemented. Details of various hardware and software components included in the Internet (such as servers, routers, gateways, etc.) are not shown. Further, it is understood that access to the Internet by media composition apparatus 110 and interface devices 190, 191, and 192 can be through suitable transmission medium, such as optical cable, coaxial cable, telephone wire, wireless RF (radio frequency) links, or the like. Communication between media composition apparatus 110 and interface devices 190, 191, and 192 can take place using an established protocol.

Media composition apparatus 110 is merely exemplary and is not limited to the embodiments presented herein. Media composition apparatus 110 can be employed in many different embodiments or examples not specifically depicted or described herein.

In some embodiments, media composition apparatus 110 can include: (a) an upload module 111; (b) an indicator module 112; (c) a query module 113; (d) a sequencer module 114; (e) a media player 115; (f) a storage component 116 storing a database 117; and (g) a user interface module 120.

Database 117 can be a structured collection of records or data that is stored in storage component 116. For example, database 117 can be XML (Extensible Markup Language) database, MySQL, or an Oracle® database. In the same or different embodiments, database 117 could consist of a searchable group of individual data files stored in storage component 116. In this embodiment, the group of files may or may not be indexed in a master file.

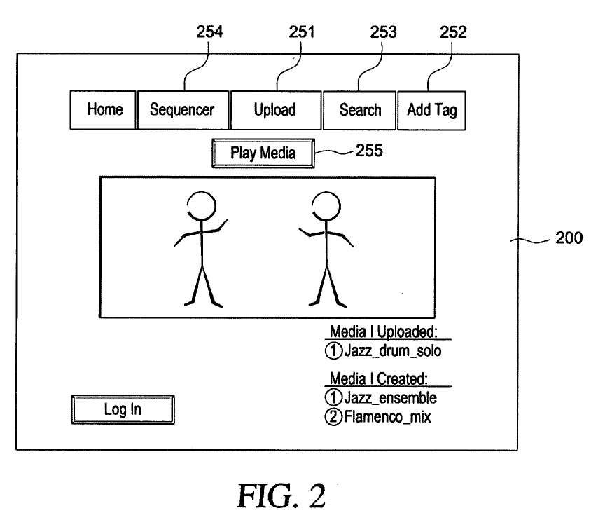

User interface module 120 can be configured to render a graphical user interface (GUI) 121 on one or more of display units 193, 194, and 195. FIG. 2 illustrates an example a main window 200 of GUI 121, according to the first embodiment. GUI 121 allows users of interface devices 190, 191, and 192 (FIG. 1), among other things, to upload, search, modify, create, and play media files through interface devices 190, 191, and 192 (FIG. 1). As described in detail below, main window 200 can include buttons 251, 252, 253, 254, and 255 to facilitate the uploading, searching, modifying, creating, and playing of the media files.

Referring again to FIG. 1, upload module 111 can be configured to upload or facilitate copying of media files. That is, upload module 111 stores a media file received over the Internet from users of interface devices 190, 191, and 192 to database 117. Upload module 111 can be configured to facilitate a first user at a first location (e.g., the user of interface device 190) to upload or copy one or more first media files to media composition apparatus 110. Likewise, upload module 111 can be further configured to facilitate a second user at a second location (e.g., the user of interface device 191) to upload or copy one or more second media files to media composition apparatus 110. In some examples, the first location is different from the second location. In the same or different examples, the uploading from different users can occur sequentially or simultaneously with each other. In some embodiments, main window 200 (FIG. 2) can include a button 251 (FIG. 2) that a user can click or push to activate upload module 111 and begin the uploading of media files process.

The media files can be files using one of many computer file formats or file types. In some embodiments, if the media file is an audio file, the media file can be a musical instrument digital interface (MIDI), waveform (WAV), MPEG-1 Audio Layer 3 (MP3), Pulse-code modulation (PCM), or windows media audio (WMA) file. For example, the media file could be a 16 bit, 44.1 kilohertz, mono or stereo PCM WAV file. The media file can also be a video file with or without audio. Other types of media files are also possible.

Indicator module 112 can be configured to facilitate tags or indications of contents and other information to be added to an uploaded media file. That is, indicator module 112 can store one or more tags received over the Internet from users of interface devices 190, 191, and 192 to database 117. In some embodiments, main window 200 (FIG. 2) can include a button 252 (FIG. 2) that a user can click or push to activate indicator module 112 and to begin the process of adding the tags to the uploaded media file.

Indicator module 112 can include: (a) an identifying module 131 configured to identify the media file type of uploaded media files; (b) an user entry module 132 configured to facilitate a user entering information regarding the uploaded media files; and (c) a media file modification module 133 configured to add and save the one or more indications to the uploaded media files.

Query module 113 can be configured to allow the users of interface devices 190, 191, and 192 to search the tags of the media files stored in database 117. In some embodiments, main window 200 can include a button 253 (FIG. 2) that a user can click or push to activate query module 113 and begin the process of searching the tags of the media files stored in database 117.

Sequencer module 114 can be configured to allow a user to create a composite media file by combining media files stored in database 117. In some examples, sequencer module 114 can be an audio or music sequencer and can provide the ability for the users to mix audio files. For example, sequencer module 114 can allow the user to edit the audio files, balance the relative volumes, frequency, quality, and dynamic content of the audio in the media files. In some examples, sequencer module 114 can allow a user to create composite media file using media files not stored in database 117, such as for example, those media files stored locally on interface devices 190, 191, and/or 192.

In the same or different embodiments, sequencer module 114 can allow the user to match the beats and control the pitch of the media files. In some embodiments, main window 200 (FIG. 2) can include a button 254 (FIG. 2) that a user can click or push to activate sequencer module 114 and to begin combining and modifying the media files. In other embodiments, sequencer module 114 can allow the user to combine and modify video files stored in database 117.

Media player 115 can be configured to allow the user to play and download media files stored in database 117 or created using sequencer module 114. When the media files are audio files, media player 115 can be an audio player. In the example when the media files are video files, media player 115 can be a video player. In some embodiments, main window 200 (FIG. 2) can include a button 255 (FIG. 2) that a user can click or push to activate media player 115 and to begin playing the media files.

In the same or different embodiments, media composition apparatus 110 can include a bridge module 119 that allows the media composition apparatus 110 to interface with other apparatuses, devices, and/or websites. For example, bridge module 119 can allow a user to upload, link, and/or copy a media file created with media composition apparatus 110 to a social networking website (e.g. MySpace® or FaceBook®) or other website to share the media file with their friends, family, and fans. In some embodiments, bridge module 119 can be configured to use an Application Programming Interface (API) of the social networking website or other website to interface, upload, link and/or copy the media file from the media composition apparatus 110.

In another example, bridge module 119 could allow a user to download a media file to a another device or apparatus (e.g. a cellular telephone or a digital media player). In various examples, main window 200 (FIG. 2) could include a button that a user can click or push to activate bridge module 119 and to begin the process of uploading, linking, or copying a media file to other apparatuses, devices, and/or websites.

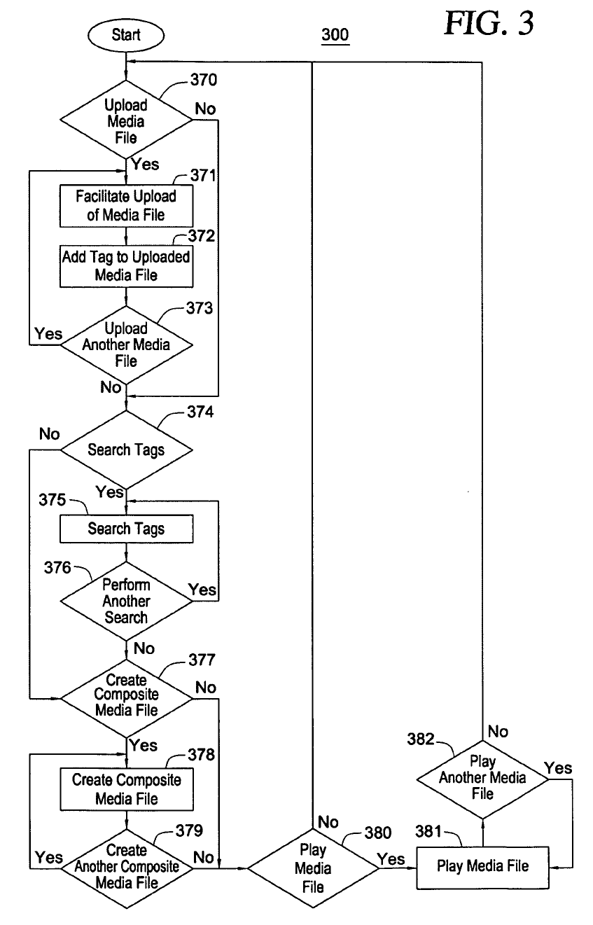

FIG. 3 is a flow chart illustrating a method 300 for generating a composite media file, according to the first embodiment. Method 300 or portions thereof can also be considered a method of combining a first audio file and a second audio file. It should be appreciated that method 300 is merely illustrative of techniques for implementing the various aspects of an embodiment described herein and that media composition apparatus 110 (FIG. 1) and method 300 are not limited to this particular embodiment, as numerous other embodiments are possible.

Referring to FIG. 3, the first activity in method 300 is an activity 370 of deciding whether to upload a media file. In some examples, users of interface devices 190, 191, and 192 (FIG. 1) can decide whether they want to upload a media file. In various embodiments, the user can click or push button 251 (FIG. 2) to begin the uploading process. If the user does not want to upload a media file, the next activity in method 300 is an activity 374.

If a user wants to upload a media file, the next activity in method 300 is an activity 371 of facilitating uploading of a media file. In some examples, facilitating the upload of a media file involves copying and storing a media file in database 117 (FIG. 1). In some examples, the user of interface device 190 (FIG. 1) at a first location can upload a first media file, and the user of interface device 191 (FIG. 1) at a second location can upload a second media file. The first location can be the same or different from the second location. In a different embodiment, the same user uploads both media files from the same or different locations.

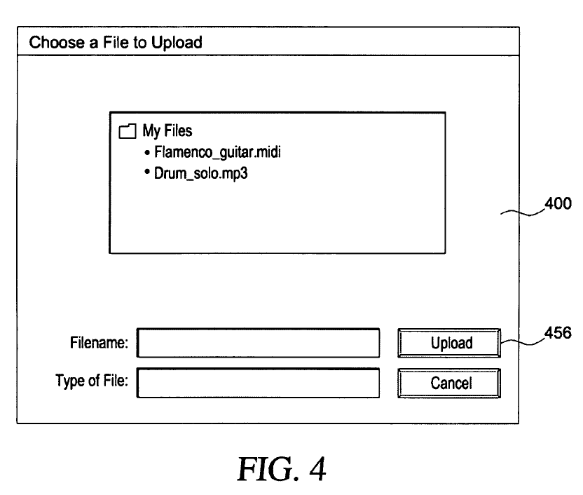

In various embodiments, after the user clicks or pushes button 251 (FIG. 2) in activity 370, upload module 111 (FIG. 1) will cause an upload window to open as part of GUI 121 (FIG. 1) in activity 371. FIG. 4 illustrates an example of an upload window 400, according to the first embodiment. In this example, the user can select a media file stored on interface device 190 (FIG. 1) to upload. After the user selects the media file and presses the upload button 456, upload module 111 (FIG. 1) copies the media file from interface device 190 (FIG. 1) into database 117 (FIG. 1).

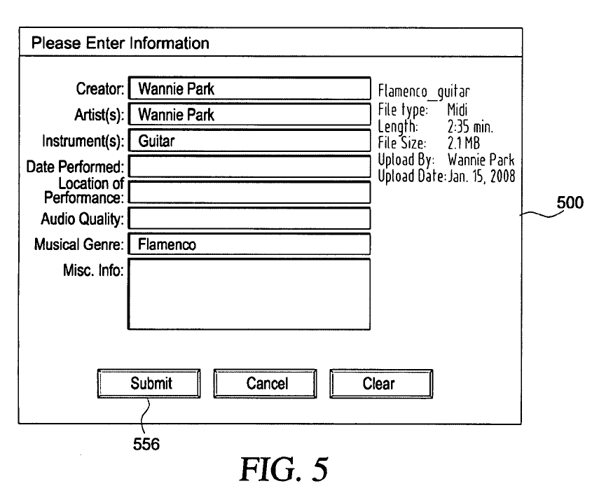

Referring again to FIG. 3, method 300 continues with an activity 372 of adding tags to the uploaded media file. In one embodiment, activities 371 and 372 can be performed in reverse order or simultaneously. In some embodiments, after the user clicks upload button 456 (FIG. 4), an indictor window is opened as part of GUI 121 (FIG. 1) by user entry module 132 (FIG. 1). FIG. 5 illustrates an example of an indication window 500, according to the first embodiment. In this example, the user can enter information about the uploaded file into indication window 500. For example, the user can enter the content of the uploaded media file, the instrument(s) used or recorded in the uploaded media file, a musical genre of the media file, the composer and/or performer of the media file, and/or the quality of the media file. For example, the quality can be an analog or digital recording. After the user has input the information regarding the uploaded media file, the user presses submit button 556 to submit the information to be stored in database 117 (FIG. 1) In one embodiment, the user can change the information regarding the uploaded file after pressing the submit button 556.

In another embodiment, after the user clicks the submit button 556, the user is returned to main window 200 (FIG. 2) and indicator module 112 (FIG. 1) associates the information entered into indication window 500 with the upload media file. In the same or different embodiments, identifying module 131 (FIG. 1) can scan or analyze the uploaded media file to determine information about the uploaded media file (e.g. file type, size of file, duration of the audio track, number of tracks).

In some embodiments, media file modification module 133 (FIG. 1) adds tags to the uploaded media file with the user-entered information, information gathered by identifying module 131 (FIG. 1), and general information (e.g., a copyright notice) and stores the tags in database 117. For example, media file modification module 133 (FIG. 1) can add the user-entered information to the meta-data of the uploaded file and save the uploaded file. In another example, indicator module 112 (FIG. 12) can add the user-entered information into the entry in database 117 (FIG. 1) containing information about the uploaded media file. In still another example, indicator module 112 (FIG. 1) can create a data file in database 117 containing the user-entered information and associate the data file with the uploaded media file.

Referring again to FIG. 3, the subsequent activity in method 300 is an activity 373 of deciding whether to upload another media file. If a user wants to upload another media file, the next activity in method 300 is activity 371. In some embodiments, the user can indicate that she wants to upload another media by clicking or pushing button 251 (FIG. 2) in main window 200 (FIG. 2).

If the user indicates she does not want to upload another media file, the next activity in method 300 is activity 374 of deciding whether to search the tags of the media files stored in database 117 (FIG. 1). In some examples, the user can indicate the she wants to search database 117 (FIG. 1) by clicking or pushing search button 253 (FIG. 2) in main window 200 (FIG. 2). If the user does not want to search database 117 (FIG. 1), the next activity in method 300 is an activity 377.

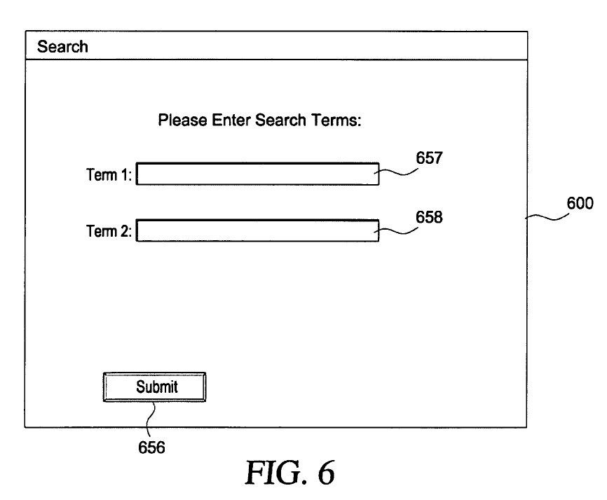

If the user wants to search the tags, the subsequent activity in method 300 is an activity 375 of searching the tags. In some embodiments, when the user clicks or pushes search button 253 (FIG. 2), query module 113 (FIG. 1) will cause a search window to open as part of GUI 121 (FIG. 1). FIG. 6 illustrates an example of a search window 600, according to the first embodiment. In this example, the user can enter search terms in fields 657 and 658 and click submit button 656 to begin the search. In some embodiments, the search is performed over the Internet.

After the user clicks or pushes submit button 656, query module 113 searches the tags of media files in database 117 for the search terns. For example, if the user searches for “flamenco guitar,” query module 113 searches the tags of the media files stored in database 117 for “flamenco guitar.” Query module 113 (FIG. 1) returns the name of any media files with the search term and causes the search results to be displayed in a results window (not shown) in GUI 121 (FIG. 2). In other examples, the search results (e.g. the names of the media file with the search terms in the tags) are displayed in main window 200 (FIG. 2).

After viewing the search results, in one embodiment, the user can change the information shared in the one or more tags of the located media files, and/or the user can add one or more new tags. The user can also listen to and/or download the media file before or after making such changes or additions.

In some embodiments, the user performing the search can be the same or different than the one or more persons who uploaded the media files returned by the search. For example, a first user of interface devices 190 could have uploaded a first media file, a second user of interface device 191 could have uploaded a second media file, and a third user of interface device 192 could have performed a search that returned the first and second media files.

Referring again to FIG. 3, the subsequent activity in method 300 is activity 376 of performing another search. If a user wants to perform another search, the next activity in method 300 is activity 375. In some embodiments, the user can indicate that she wants to perform another search by clicking or pushing button 253 (FIG. 2) in main window 200 (FIG. 2).

If the user does not want to perform another search, method 300 of FIG. 3 continues with an activity 377 of deciding whether to create a composite media file. In some examples, the user can indicate that she wants to create a composite file by clicking or pushing sequencer button 254 (FIG. 2) in main window 200 (FIG. 2) to begin the creating a composite media file process. If the user does not want to create a composite media file, the next activity in method 300 is an activity 380.

If the user wants to create a composite media file, the next activity in method 300 of FIG. 3 is an activity 378 of creating the composite media file. In some examples, creating the composite media file can include combining or reworking two or more media files. In some examples, the user can alter or modify one or more of the media files while the creating the composite media file. In other examples, creating the composite media file can include altering or modifying a single media file to create the composite media file. In still other examples, the composite media can comprise portions of the two or more media files.

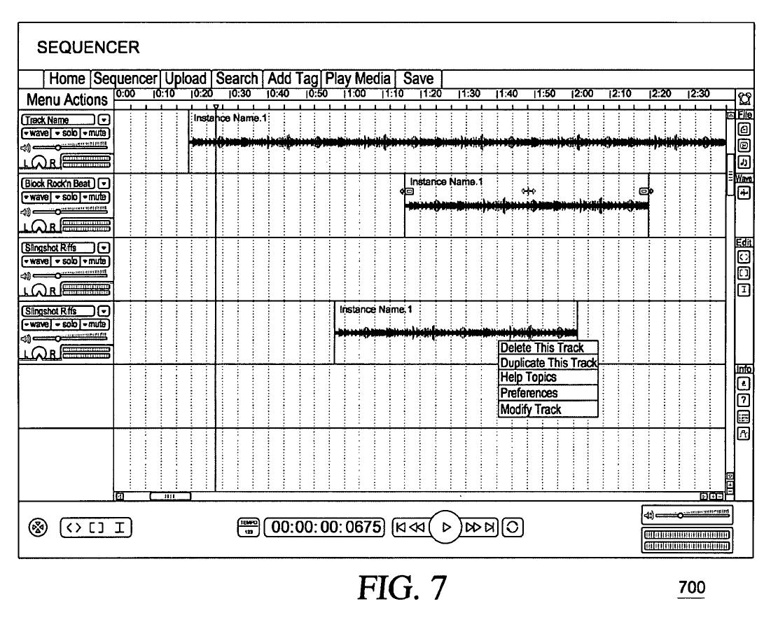

In some embodiments, when the user clicks or pushes sequencer button 253 (FIG. 2), sequencer module 114 (FIG. 1) will cause a sequencer window to open as part of GUI 121 (FIG. 1). FIG. 7 illustrates an example or a sequencer window 700, according to the first embodiment. In some examples, sequencer module 114 can be a visual sequencer (e.g. a sequencer with a drag and drop interface) showing all of the selected audio files and including a staff, a treble clef, and a bass clef. In various embodiments, the user could use the clef and the bass clef to modulate the audio in the audio file up or down the musical scale. For examples, if a user has an audio sample of a guitar loaded into the sequencer, the user can, for example, drop the guitar sample from G down to middle C using sequencer module 114 (FIG. 1).

In the same or different example, the user can edit the relative volumes of the media files, add filters, loops, echoes, sound effects, or reverberations, and time-stretch or pitch shift portions of the media files. In the example, shown in FIG. 7, four media files are loaded into sequencer module 114, and the user can combine parts of two or more of the media files into a composite media file. In some examples, after the user creates the composite media file, the composite media file can be stored in database 117 (FIG. 1) and/or download by the user to interface device 190, 191, or 192.

The creation of the composite file can be performed locally or remotely over the Internet. If the composite file is created locally, then the composite file can be uploaded to the database over the Internet, and if the composite file is created remotely, the composite file can be downloaded to the user's local computer.

Referring again to FIG. 3, the subsequent activity in method 300 of FIG. 3 is an activity 379 of deciding whether to create another composite file. If a user wants to create another composite file, the next activity in method 300 is activity 378. In some embodiments, the user can indicate that she wants to create another composite file by clicking or pushing button 254 (FIG. 2) in main window 200 (FIG. 2).

If the user does not want to create another composite file, method 300 of FIG. 3 continues with an activity of deciding whether to play a media file. In some examples, the user can indicate the she wants to play a media file by clicking or pushing play button 255 (FIG. 2) in main window 200 (FIG. 2). If the user does not want to play a media file, the next activity in method 300 is activity 370.

If the user wants to play a media file, the next activity in method 300 of FIG. 3 is an activity 381 of playing the media file. In some examples, the media file played can be the composite media file created in activity 378 or another media file stored in database 117 (FIG. 1). In some embodiments, activity 381 can include downloading and storing the media file locally before or after playing the media file.

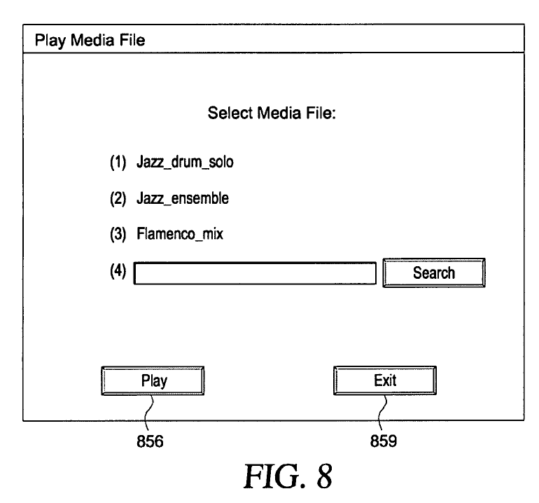

In some embodiments, when the user clicks or pushes play button 255 (FIG. 2), media player 115 (FIG. 1) will cause a media player window to open as part of GUI 121 (FIG. 1). FIG. 8 illustrates an example of a media player window 800, according to the first embodiment. In this example, the user can select a media file from database 117 (FIG. 1) to play. Also, a user can enter or search for a media file in database 117 (FIG. 1). After the user selects the media file to play, the user clicks or pushes play button 856. For example, when the user of interface device 190 (FIG. 1) clicks or pushes play button 856, media player 115 (FIG. 1) will cause the audio and/or video stored in the selected media file to play on interface device 190 (FIG. 1).

Referring again to FIG. 3, after the media file is played, the next activity in method 300 is an activity 382 of deciding whether to play another media file. The user can indicate she does not want to play another media file by pressing exit button 859 (FIG. 8). If the user does not want to play another media file, the next activity in method 300 is activity 370. If the user wants to play another media file, the next activity in method 300 is activity 381.

In some embodiments, the order of activities 370-382 can vary. For example, activities 374-376 can take place before activities 370-373 or after activities 377-379 and/or 380-382. Likewise, activities 377-379 and/or 380-382 can take place before activities 370-373 and/or activities 374-376. In the same or different embodiments, the user can select the order of activities 370-382 by selecting one of buttons 251-255 (FIG. 2) in main window 200 (FIG. 2).

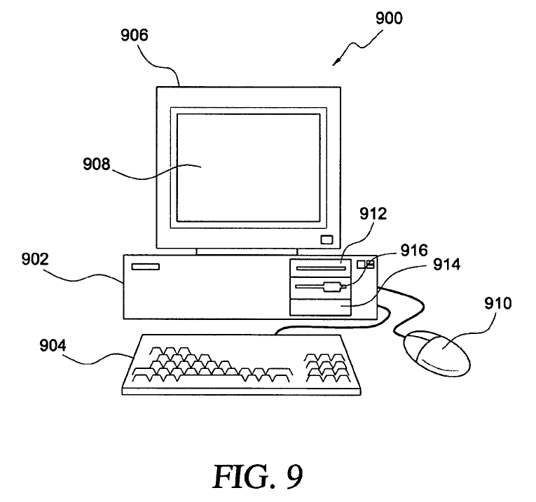

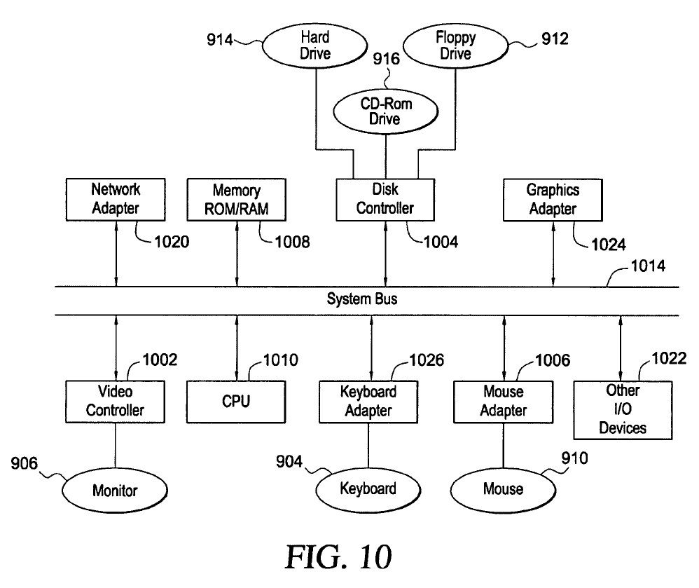

FIG. 9 illustrates a computer 900 that is suitable for implementing an embodiment of media composition apparatus 10 (FIG. 1). Computer 900 can also be an example a device suitable for use as interface devices 190, 191, and 192 (FIG. 1). Computer 900 includes a chassis 902 containing one or more circuit boards (not shown), a floppy drive 912, a Compact Disc Read-Only Memory (CD-ROM) drive 916, and a hard drive 914. A representative block diagram of the elements included on the circuit boards inside chassis 902 is shown in FIG. 10. A central processing unit (CPU) 1010 in FIG. 10 is coupled to a system bus 1014 in FIG. 10. In various embodiments, the architecture of CPU 1010 can be compliant with any of a variety of commercially distributed architecture families including the RS/6000 family, the Motorola 68000 family, or the Intel x86 family.

System bus 1014 also is coupled to memory 1008 that includes both read only memory (ROM) and random access memory (RAM). Non-volatile portions of memory 1008 or the ROM can be encoded with a boot code sequence suitable for restoring computer 900 (FIG. 9) to a functional state after a system reset. In addition, memory 1008 can include microcode such as a Basic Input-Output System (BIOS).

In the depicted embodiment of FIG. 10, various I/O devices such as a disk controller 1004, a graphics adapter 1024, a video controller 1002, a keyboard adapter 1026, a mouse adapter 1006, a network adapter 1020, and other I/O devices 1022 can be coupled to system bus 1014. Keyboard adapter 1026 and mouse adapter 1006 are coupled to a keyboard 904 (FIGS. 9 and 10) and a mouse 910 (FIGS. 9 and 10), respectively, of computer 900 (FIG. 9). While graphics adapter 1024 and video controller 1002 are indicated as distinct units in FIG. 10, video controller 1002 can be integrated into graphics adapter 1024, or vice versa in other embodiments. Video controller 1002 is suitable for refreshing a monitor 906 (FIGS. 9 and 10) to display images on a screen 908 (FIG. 9) of computer 900 (FIG. 9). Disk controller 1004 can control hard drive 914 (FIGS. 9 and 10), floppy drive 912 (FIGS. 9 and 10), and CD-ROM drive 916 (FIGS. 9 and 10). In other embodiments, distinct units can be used to control each of these devices separately.

Although many other components of computer 900 (FIG. 9) are not shown, such components and their interconnection are well known to those of ordinary skill in the art. Accordingly, further details concerning the construction and composition of computer 900 and the circuit boards inside chassis 902 (FIG. 9) need not be discussed herein.

When computer 900 in FIG. 9 is running, program instructions stored on a floppy disk in floppy drive 912, on a CD-ROM in CD-ROM drive 916, on hard drive 914, or in memory 1008 (FIG. 10) are executed by CPU 1010 (FIG. 10). A portion of the program instructions, stored on these devices, can be suitable for carrying out the method of generating a composite media file with system 100 (FIG. 1) as described previously with respect to FIGS. 1-8.

Although the invention has been described with reference to specific embodiments, it will be understood by those skilled in the art that various changes may be made without departing from the spirit or scope of the invention. For example, sequencer module 114 could be replaced with a video editing module when the media files are video files. Also, more than three units can use system 100 sequentially or simultaneously. Additional examples of such changes have been given in the foregoing description. Accordingly, the disclosure of embodiments is intended to be illustrative of the scope of the invention and is not intended to be limiting. It is intended that the scope of the invention shall be limited only to the extent required by the appended claims. To one of ordinary skill in the art, it will be readily apparent that the apparatus and methods discussed herein may be implemented in a variety of embodiments, and that the foregoing discussion of certain of these embodiments does not necessarily represent a complete description of all possible embodiments. Rather, the detailed description of the drawings, and the drawings themselves, disclose at least one preferred embodiment, and may disclose alternative embodiments.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A method of generating a composite media file, the method comprising:
storing a first media file received over an information sharing network from a first user to a database;
storing a first tag received over the information sharing network for the first media file to provide first information regarding the first media file;
storing a second media file received over the information sharing network from a second user to the database;
storing a second tag received over the information sharing network for the second media file to provide second information regarding the second media file,
facilitating a search over the information sharing network for the first media file in the database based on the first information; and
storing the composite media file comprising a combination of at least portions of the first media file and the second media file.

2. The method of claim 1, further comprising:
facilitating a search over the information sharing network for the second media file in the database based on the second information.

3. The method of claim 1, further comprising:
storing a third tag received over the information sharing network for the second media file to provide third information regarding the second media file.

4. The method of claim 3, further comprising:
facilitating a search over the information sharing network for the second media file in the database based on the third information.

5. The method of claim 4, wherein:
storing the first tag further comprises:
receiving the first information for the first tag from the first user;
storing the second tag further comprises:
receiving the second information for the second tag from the second user;
storing the third tag further comprises:
receiving the third information for the third tag from a third user;

6. The method of claim 1, further comprising:
storing a third media file received over the information sharing network from a third user to the database,
wherein:
storing the composition media file comprises:
providing the composition media file to comprise a combination of the first media file, the second media file, and the third media file.

7. The method of claim 1, wherein:
the first user is at a first location; and
the second user is at a second location different from the first location.

8. The method of claim 1, wherein:
the database is at a third location different from the first location and the second location.

9. The method of claim 1, wherein:
the combination of the first media file and the second media file comprises the second media file in a different audio key.

10. The method of claim 1, wherein:
storing the first tag comprises:
storing the first tag to comprise one or more of: a composer of the first media file, a performer of the first media file, a name of an instrument recorded in the first media file, and information regarding quality of the media file.

11. The method of claim 1, further comprising:
storing an alteration of the first tag to provide different first information regarding the first media file.

12. A method of combining a first audio file and a second audio file comprising:
uploading the first audio file over an information sharing network to a database;
adding a first indication to the first audio file in the database over the information sharing network, the first indication having information about the first audio file;
searching the database for a second indication about the second audio file over the information sharing network; and
combining at least portions of the first audio file and the second audio file into a composite audio file.

13. The method of claim 12, wherein:
combining the first audio file and the second audio file comprises:
modifying the first audio file while combining the first audio file with the second audio file into the composite audio file.

14. The method of claim 12, wherein:
combining the first audio file and the second audio file comprises:
using an audio sequencer to combine at least one of the first audio file and the second audio file.

15. The method of claim 12, wherein:
uploading the first audio file comprises:
uploading the first audio file to a database over a Internet; and
searching for the second indication comprises:
searching for the second indication in the database over the Internet.

16. The method of claim 12, wherein:
the first audio file is uploaded by a first user;
the second audio file is provided by a second user; and
the first user is different from the second user.

17. The method of claim 12, wherein:
adding the first indication to the first audio file comprises:
providing the first indication to be an instrument used in the first audio file.

18. The method of claim 12, wherein:
adding the first indication to the first audio file comprises:
providing the first tag indication to be a musical genre of the first audio file.

19. The method of claim 12 further comprising:
downloading the composite audio file over the information sharing network.

20. The method of claim 12 further comprising:
changing the first indication to comprise different information about the first audio file.

21. The method of claim 12 further comprising:
changing the second indication to comprise different information about the second file.

22. A media composition apparatus comprising:
an upload module configured to upload at least three first media files from one ore more remote locations;
an indicator module configured to facilitate coupling one or more tags to the at least three first media files;
a query module configured to allow a user to search the at least three first media files by remotely searching the one or more tags of the at least three media files; and
a sequencer module configured to allow the user to create a second media file by combining at least portions of two or more media files of the at least three first media files.

23. The media composition apparatus of claim 22, wherein:
the upload module is configured to facilitate a first user at a first location to upload a first one of the at least three media files;
the upload module is further configured to facilitate a second user at a second location to upload a second one of the at least three media files; and
the first location is different from the second location.

24. The media composition apparatus of claim 22, wherein:
the indicator module comprises:
an identifying module configured to identify a media file type of the at least three first media files;
an user entry module configured to facilitate a first user to add information regarding the at least three media files; and
a media file modification module configured to add the one or more tags to the at least three media files.

25. The media composition apparatus of claim 22, wherein:
the sequencer module comprises:
a staff;
a treble clef; and
a bass clef.

26. The media composition apparatus of claim 22, further comprising:
a media player configured to allow the user to play the second media file.

27. The media composition apparatus of claim 22, wherein:
the media player is configured to allow the user to download the second media file.
